(19) United States
(12) Patent Application Publication
(10) Pub. No.: US 2015/0304027 A1
(43) Pub. Date: Oct. 22, 2015

(54) EMISSION DEVICE FOR EMITTING A LIGHT BEAM OF CONTROLLED SPECTRUM

(71) Applicant: Mejdi NCIRI, PARIS (FR)

(72) Inventor: Mejdi NCIRI, PARIS (FR)

(73) Assignee: ARCHIMEJ TECHNOLOGY, EVRY (FR)

(21) Appl. No.: 14/399,786

(22) PCT Filed: Apr. 30, 2013
(86) PCT No.: PCT/FR2013/050957

§ 371 Date: Nov. 7, 2014

(30) Foreign Application Priority Data
May 9, 2012 (FR) 1201353
Nov. 20, 2012 (FR) 1261015
Jan. 18, 2013 (FR) 1350446

(51) Int. Cl. H04B 10/11; H04B 10/572

(52) U.S. Cl. CPC H04B 10/11; H04B 10/572

(57) ABSTRACT

An emission device (1) for emitting a light beam of controlled spectrum, includes: at least two separate light sources (Si to N) each emitting a light beam of wavelength λ1 or λ2, and spectral multiplexing elements (25). The spectral multiplexing elements (25) include an optical assembly (25) formed from at least one lens (25) and/or an optical prism. The optical assembly (25) has chromatic dispersion properties and moves the light beams spatially closer together. Moreover, each light beam having at least wavelength λ1 or λ2 propagates in free space from the corresponding light source (Si to N) to the optical assembly (25). Therefore the emission device (1) is particularly robust. It can have small dimensions and be produced at low cost.

### TECHNICAL FIELD

The present invention relates to a device for emitting a light beam with a controlled spectrum, utilizing innovative spectral multiplexing means. By spectral multiplexing is meant the spatial combination of several light beams each contributing to the final spectral composition of a combined light beam.

The field of the invention is more particularly but non-limitatively that of the spectral multiplexing of at least two wavelengths each emitted by a separate light source. The separate light sources are in particular quasi-monochromatic sources.

### STATE OF THE PRIOR ART

Various devices for emitting a light beam with a controlled spectrum are known in the prior art.

For example a spectrophotometer is known from the document “Multispectral absorbance photometry with a single light detector using frequency division multiplexing” by G. K. Kurup and A. S. Basu (14th International Conference on Miniaturized Systems for Chemistry and Life Sciences, 3-7 Oct. 2010, Groningen, The Netherlands) comprising a plurality of light-emitting diodes (hereinafter referred to as LEDs for “Light-Emitting Diodes” in English) emitting at different wavelengths: in the blue at 470 nanometres (nm), in the green at 574 nm, and in the red at 636 nm.

According to this document, the different light beams emitted by the three LEDs are each coupled with a respective optical fibre, then a fibre multiplexer (or “fibre splitter” in English) combines and mixes these different light beams.

A drawback of such a device is that it is difficult to efficiently couple the light beam emitted by a LED with an optical fibre, the numerical aperture of which is generally limited relative to the divergence of the light beam emitted by the LED. Losses of light intensity are therefore significant. Moreover, the alignment of the LED with the corresponding optical fibre must be very accurate, which limits the possibilities for industrial production and repeatability of the alignments. In addition, the fibre splitters have a significant cost.

The Colibri microscope light source marketed by Zeiss is also known, in which four beams respectively at 400 nm, 470 nm, 530 nm and 625 nm are combined using a unit comprising dichroic reflectors and mirrors. Using internal reflection sets, the four beams form a single beam of white light at the output.

A drawback of such a device is that the number of beams that can be combined is limited and can exceed four in number only with difficulty. Moreover, the greater the number of beams that it is desired to combine, the more complex and costly is the arrangement of the dichroic mirrors and the lower the energy efficiency.

An objective of the present invention is to propose a device for emitting a controlled-spectrum light beam that does not have the drawbacks of the prior art. In particular, the spectral multiplexing means of which does not have the drawbacks of the prior art.

In particular, an objective of the present invention is to propose a device for emitting a controlled-spectrum light beam that is simple in principle and in production, with the ability in particular to be produced in several examples with good reproducibility.

Another objective of the present invention is to propose a device for emitting a controlled-spectrum light beam, allowing more than three or even four light beams to be mixed, for example twelve.

Another purpose of the present invention is to propose a device for emitting a controlled-spectrum light beam at a low cost.

Another purpose of the present invention is to propose a device for emitting a controlled-spectrum light beam with good energy efficiency, in which energy losses are minimized.

### DISCLOSURE OF THE INVENTION

This objective is achieved with a device for emitting a controlled-spectrum light beam comprising at least two separate light sources each emitting a light beam at at least one wavelength λ₁ or λ₂ respectively, as well as spectral multiplexing means.

According to the invention, the spectral multiplexing means comprise an optical assembly formed of at least one lens and/or an optical prism, said optical assembly having chromatic dispersion properties and being arranged in order to be passed through by the light beams from the separate light sources, without spectrally selective reflection, and in order to move said light beams spatially closer together, so that the spectral multiplexing means spatially superimpose said light beams.

According to the invention, the emission device is moreover arranged so that each light beam at at least one wavelength λ₁ or λ₂ respectively propagates in free space from the corresponding light source to the optical assembly.

A respective wavelength is associated with each light source. Throughout the following, when a wavelength of a source, or a wavelength of an emission from a source, or a wavelength λ₁ or λ₂ respectively of a source is mentioned, this associated wavelength will be designated. Each source can emit at other wavelengths apart from this associated wavelength. Each light beam at at least one wavelength λ₁ or λ₂ respectively has in any case a certain spectral width.

The superimposed light beams form a beam known as a superimposed or multiplexed beam. The light beams can be superimposed at a point, or preferentially at infinity, then forming a single collimated multiplexed beam. The optical assembly, owing to its chromatic dispersion properties, can convert a multicoloured light beam (i.e. comprising at least two wavelengths) into at least two light beams, each at a respective wavelength.

Thus, by the principle of the inverse return of light, light beams each at at least one wavelength can be moved spatially closer together at the output of the optical assembly. The choice of use of the optical assembly in the device according to the invention is made in the light of this meaning of use. The device according to the invention can be regarded as an “inverted optical spectrometer”, using neither a diffraction grating nor a filter wheel.

The term “chromatic dispersion” according to the invention comprises chromatic aberrations.

The optical assembly is formed by at least one lens and/or an optical prism, and there is no spectrally selective reflection (i.e. reflection of a portion of the light beam at certain wavelengths only, the portion of the light beam at the other wavelengths being either transmitted or deflected in another favoured direction). In particular, there is no dichroic reflector or diffraction grating. The emission device according to the invention therefore has a simple design. The spectrally selective reflections according to the invention do not include the stray reflections which can exist in any optical system, in particular at the interfaces, and which can thus be attenuated by antireflective treatments.

The chromatic dispersion properties of the optical assembly, as well as the principle of the inverse return of light, make it possible to move the light beams spatially closer together. The cost of production of such a device is therefore reduced. Moreover, it is therefore possible to multiplex spectrally in a simple fashion more than four light beams the respective spectra of which are each centred on a respective wavelength.

The propagation of a light beam emitted by an associated light source takes place in free space from said source to the optical assembly. By “free space” is meant any spatial medium for routing the signal: air, interstellar medium, vacuum, etc, as opposed to a material transport medium, such as optical fibre or wired or coaxial transmission lines. Thus there is no coupling between the light beam emitted by a light source, and a waveguide. There is no coupling known as “fibre-to-fibre” such as may be present in devices of the prior art. The device according to the invention thus has little energy loss. The light beams are efficiently mixed, and the intensity of the superimposed beam is high. Moreover, this feature offers greater freedom of positioning of the light sources which reduces the cost of production of the device according to the invention and enables series production.

Preferably, the light sources emit at wavelengths situated in the visible (between 400 nm and 800 nm).

The light sources can emit light beams having spectral widths greater than 6 nm.

According to an advantageous variant of the invention, the spectral multiplexing means are formed by the optical assembly only. In this variant, the optical assembly alone moves the light beams spatially closer together and superimposes them.

Advantageously, each light source is placed on an object focus of the optical assembly, where said object focus corresponds to the wavelength of the light beam emitted by this light source, so that at the output of the optical assembly the light beams are spatially superimposed and collimated.

An advantage of this variant is that it requires a minimum of optical elements. The production cost of the device according to the invention is thus reduced. This variant may be known as the “infinite point” variation.

For example, in this conventional configuration, the optical assembly converts a light beam that has parallel rays (known as a “collimated” beam) and is multicoloured (i.e. comprising at least two wavelengths), into at least two light beams converging respectively on two distinct and separate foci of the optical assembly and corresponding to the two wavelengths of the multicoloured light beam.

By the principle of the inverse return of light, if two light sources, each emitting a light beam, are placed at the object foci corresponding to their respective emission wavelengths, then the light beam leaving the optical assembly will be a collimated light beam in which the light beams emitted by each of the light sources are superimposed and mixed. This second configuration is then utilized in the device according to the invention.

Alternatively, each light source is placed at an object point of the optical assembly, where said object point corresponds to the wavelength of the light beam emitted by this light source, so that at the output of the optical assembly the light beams are spatially superimposed at a single image point.

This alternative corresponds to the equivalent in “point-point” conjugation of the “infinite point” variant.

According to another variant of the invention, the spectral multiplexing means comprise the optical assembly, an homogenization waveguide and optical collimation means, the optical assembly being arranged to send the light beams to the input of the homogenization waveguide, i.e. the homogenization waveguide at the output of which the optical collimation means are located.

The homogenization waveguide makes it possible to carry out a function of homogenization of the different light beams moved spatially closer together by the optical assembly. At the output of the homogenization waveguide a homogenous beam is obtained which is collimated by the optical collimation means.

An homogenization waveguide typically has a core diameter greater than or equal to 1 mm, which makes it possible to carry out this homogenization function which could not be performed by a “conventional” optical fibre.

The optical collimation means are preferably achromatic.

The homogenization waveguide can be formed by a liquid-core optical fibre. An advantage of such an optical fibre is its large diameter (for example 5 mm and up to 10 mm in diameter), ensuring that even when distributed over a large volume (for example a cylinder 5 mm in diameter and 3 mm thick) light beams are located at the input of the optical fibre. A smaller movement spatially closer together of the light beams, implemented by the optical assembly, can be compensated by the use of such an homogenization waveguide.

According to a variant, the homogenization waveguide can be formed by a hexagonal homogenizing rod. Sometimes the term “light pipe” is used. It is possible for example to use a TECHSPEC® homogenizing rod made from N-BK7 material.

According to another variant, a spatial filtering system can be used for carrying out the homogenization function. For example, the optical assembly focuses the light beams on a focal point or a focal zone, at the level of which there is a simple filtering hole.

Preferably, the separate light sources are arranged to be coplanar.

The separate light sources can be aligned in a straight line and ranked in increasing order of wavelength λ₁ or λ₂ respectively (i.e. by increasing order of wavelength associated with the light source).

According to a particular embodiment of the invention, the optical assembly comprises at least one optical system used off-axis and having a lateral chromatic aberration. This lateral chromatic aberration forms the chromatic dispersion property according to the invention.

The off-axis use accentuates the lateral spatial dispersion of the wavelengths, or even causes it to disappear. This may also be known as chromatism of apparent magnitude.

The cost of such an optical system is generally low because intrinsically, any optical system utilized off-axis presents lateral chromatic aberration, if it is not specifically corrected for this aberration by means of known solutions in optical design.

The light sources can be placed respectively at the foci of the optical system corresponding to the wavelengths λ₁ and λ₂, so that their light beams are multiplexed at the output of the optical system.

The optical system is said to be “used off-axis”, i.e. off its optical axis. In other words, an incident light beam, convergent with the object focus of the optical system, does not leave this optical system parallel to the optical axis of said system. Thus, the foci of the optical system corresponding to different wavelengths are sufficiently separate to be able to place the corresponding light sources at the location of these foci. In this way, the spectral multiplexing is accurately and automatically carried out by the aberrant optical system used off-axis.

According to a variant, the optical assembly comprises at least one optical system used on-axis and having a lateral chromatic aberration.

The light sources can be quasi-monochromatic, each emitting a light beam at the wavelengths λ₁ or λ₂ respectively.

The emission device can form a source part of an absorption spectrometer, the spectral multiplexing means according to the invention being capable of mixing the light beams in order to form a multiplexed (or superimposed) light beam intended to illuminate a sample to be analysed.

According to a variant of this embodiment, the optical assembly comprises a doublet or triplet lens, usually used for the correction of chromatic aberrations. The doublet or triplet lens is thus employed outside its design use. For example a crown-flint doublet (from the name of the two types of glass used for each of the two lenses of the doublet).

According to another variant of this embodiment, the optical assembly comprises an optical prism and optical focussing means and/or optical collimation means. Typically, the optical assembly comprises:
optical collimation means, arranged in order to form and direct collimated light beams from the light sources to the optical prism; and
optical focussing means, arranged in order to direct light beams emerging from the prism to a common focus point.

It can be considered that any optical system for spectral decomposition comprising at least one lens and/or an optical prism, used in the inverse direction, can be utilized as an optical assembly according to the invention.

Preferably, each light source is a light emitting diode (LED). A LED is a quasi point source emitting a divergent light beam.

The emission device according to the invention can contain more than three light sources, for example at least five, eight, or twelve, or even at least twelve light sources. It is even possible to envisage several tens of light sources.

The wavelengths of the light sources can be comprised between 340 nm and 800 nm.

The emission device according to the invention can moreover comprise modulation means arranged in order to modulate the light intensity of at least two of the light sources at frequencies that are different from each other.

In particular, the device according to the invention comprises modulation means arranged in order to modulate the light intensity of each light source, independently of each other.

The contribution of each light source in the multiplexed beam can thus be discovered easily by utilizing frequency filtering detection, for example synchronous detection. A signal-to-noise ratio of a detector receiving the multiplexed beam can thus be improved, in particular as the signals only experience interference from noise at the observed frequency.

Preferably, the device according to the invention also comprises means for controlling the light intensity of at least two of the light sources, independently of each other.

In particular, the device according to the invention comprises means for controlling the light intensity of each light source, independently of each other.

The energy contribution of each light source in the multiplexed beam can thus be easily controlled.

A spectrum-controlled multispectral source is obtained, the intensity of each spectral contribution being independently controlled.

For example the light sources according to the invention can be turned on singly in turn. At each moment, the energy contribution of all the light sources except one is zero. Such an embodiment makes it possible for example to produce a device for the emission of a light beam for an absorption spectrometer. In such a spectrometer, instead of sending white light to a sample the wavelength of which must then be decomposed after passing through the sample, at each instant only a single wavelength is sent (of course, subject to the spectral width of each light source). Thus a final step of spectral decomposition is dispensed with. A choice is made to control the emission device instead of separating the wavelengths in the beam transmitted by the sample. Alternatively, all the light sources can be turned on at the same time, but using the modulation means as defined above, still dispense with a final step of spectral decomposition by spatial separation in an absorption spectrometer.

The light intensity control means can moreover make it possible to adapt the light intensity of each light source to an absorption by a sample and/or a response of a detector.

The invention also relates to a installation M² for the emission of a controlled-spectrum light beam, comprising at least two devices M for the emission of a controlled-spectrum light beam according to the invention, each device M supplying a light beam known as superimposed, the installation M² for the emission of a controlled-spectrum light beam comprising moreover auxiliary spectral multiplexing means arranged in order to spatially superimpose the respective superimposed light beams of each device M for the emission of a controlled-spectrum light beam.

Even more beams can thus be superimposed, in particular quasi-monochromatic beams. In particular, at least twice as many light beams can be superimposed compared to an emission device according to the invention.

The auxiliary spectral multiplexing means advantageously comprise any conventional multiplexing means. A few examples are given below.

The auxiliary spectral multiplexing means can comprise an assembly of at least one dichroic mirror. Using reflection or transmission sets, light beams each associated with a respective emission device can be spatially superimposed.

The auxiliary spectral multiplexing means can comprise a fibre multiplexer arranged in order to multiplex together light beams originating from its several input optical fibres. The term “Fibre splitter” can be used for such a fibre multiplexer.

Each device for emitting a controlled-spectrum light beam can comprise a respective waveguide, and optical collimation means common with the other devices for the emission of a controlled-spectrum light beam, and the auxiliary spectral multiplexing means are arranged for multiplexing the light beams originating from each of the waveguides. In particular, each device for emitting a controlled-spectrum light beam can comprise a respective homogenization waveguide. In these variants, a waveguide (optionally an homogenization waveguide) corresponds to each emission device in which light beams that are superimposed or moved closer together by the corresponding optical assembly propagate. The outputs of the different waveguides are multiplexed (or mixed) by the fibre splitter, then collimated by the common optical collimation means.

The invention also relates to a spectrometer for analyzing at least one sample, comprising means for illuminating the sample. The means for illuminating the sample comprise a device M for the emission of a controlled-spectrum light beam according to the invention or an installation M² for the emission of a controlled-spectrum light beam according to the invention.

The spectrometer according to the invention can form an absorption spectrometer and comprise:
at least one detector capable of collecting a light beam transmitted by the sample to be analysed and delivering a signal relating to the light flux received by the detector at wavelengths λ₁ or λ₂ respectively, and
signal processing means capable of determining the absorption of each of the wavelengths λ₁ or λ₂ respectively, by the sample to be analysed.

As the absorption spectrometer according to the invention, unlike conventional absorption spectrometers, does not use costly and bulky optical components such as a diffraction grating or a multi-channel linear detector (for example CCD sensor or photodiode array), its cost remains controlled.

Moreover, the spectrometer according to the invention incorporates the light source directly. The absorption spectrometer according to the invention can comprise modulation means arranged in order to modulate the light intensity of each of the light sources at frequencies that are different from each other, and signal processing means arranged for demodulating the signal delivered by the detector synchronously with the light sources.

Advantageously, the absorption spectrometer according to the invention comprises the variant of the emission device or emission installation according to the invention, comprising means for controlling the light intensity of at least two of the light sources, independently of each other.

Thus, as described previously, the principle implemented is fundamentally different, since it consists of controlling the emission (by modulation, or activation of a single source at once) instead of spectrally decomposing along a line of detection the light beam transmitted by the sample to be analysed. The absorption spectrometer according to the invention thus has numerous other advantages:
its sensitivity to interfering light is limited although its measurement dynamics are extensive and its detection threshold low with respect to an absorption spectrometer using a light diffraction grating, and
its measurement speed is improved with respect to a monochromatic spectrometer which involves a mechanical movement to scan the measurement spectrum (filter wheel or diffraction grating monochrometer). This speed is even better in the variant utilizing light intensity modulation.

In fact, in the prior art, the spectral decomposition of the beam transmitted by the sample is not perfect. At a given location on the line of detection it is found that: the major portion (but not the whole) of the component at a wavelength λ₁, and there is interfering light at all the other wavelengths of the transmitted beam. This interfering light is essentially due to the diffusion introduced by the use of a diffraction grating. The change of principle, consisting of operating instead on controlling the emission, solves this drawback.

The absorption spectrometer according to the invention can contain at least one optical fibre in which the multiplexed light beam illuminating the sample to be analysed is coupled.

The absorption spectrometer according to the invention can contain optical collimation means arranged at the output of the device or of the installation according to the invention, so as to direct a collimated light beam toward the sample.

The absorption spectrometer according to the invention can comprise feedback means capable of modifying the light intensity of each light source as a function of the absorption of each of the wavelengths λ₁, λ₂ (and if applicable λ_{1 to N, i>2}) by the sample to be analysed. Thus operating in the best area of sensitivity and linearity of the detector is ensured. In this way the signal-to-noise ratio is improved.

The spectrometer according to the invention can form a fluorescence spectrometer and can comprise:
at least one detector arranged for collecting a fluorescence light beam emitted by the sample to be analysed and
signal processing means arranged in order to deliver a signal relating to the light flux (of the fluorescence light beam) received by the detector as a function of the wavelength λ₁ or λ₂ respectively received by the sample.

The wavelength λ₁ or λ₂ respectively received by the sample is generally known as an excitation wavelength.

The detector can be arranged so as to detect only a predetermined spectral band.

The fluorescence spectrometer is particularly advantageous, in the variant in which the emission device (or emission installation) according to the invention comprises means for controlling the light intensity of at least two of the light sources, independently of each other. In this case, the signal processing means deliver a signal relating to the light flux received by the detector as a function of a given intensity (of excitation) of each wavelength λ₁ or λ₂ respectively and of a duration of excitation. The duration of excitation is controlled via the light intensity control means. Time-resolved fluorescence can thus be realized. Depending on the duration of excitation, different molecules do not undergo the same excitation. It is less costly to work on a rapid excitation time than on rapid detection. The invention makes it possible to preferably work on a rapid excitation time, for example by means of using LEDs.

For example, the detector comprises a simple intensity detector, and the signal processing means deliver a signal relating to the total intensity of the fluorescence light beam received by the detector as a function of the excitation wavelength (wavelength λ₁ or λ₂ respectively received by the sample).

Alternatively, or in addition, the detector can comprise a spectrometer, and the signal processing means deliver a signal relating to the fluorescence spectrum of the fluorescence light beam received by the detector as a function of the excitation wavelength.

The fluorescence spectrometer can comprise feedback means capable of modifying the light intensity of each light source as a function of the intensity of the fluorescence light beam emitted by the sample in response to the absorption of the corresponding wavelength λ₁ or λ₂ respectively.

The fluorescence spectrometer according to the invention can comprise modulation means arranged in order to modulate the light intensity of each of the light sources at frequencies that are different from each other, and signal processing means arranged for demodulating the signal delivered by the detector synchronously with the light sources.

The absorption spectrometer according to the invention or the fluorescence spectrometer according to the invention can comprise a reference channel: a portion of the light beam emitted by the means for lighting the sample is not directed toward the sample to be analysed but toward a reference sample. Thus a reference can be available so as to calculate an absorption respectively a signal relating to the light flux received by the detector as a function of the wavelength λ₁ or λ₂ respectively received by the sample. Rather than a reference sample, provision can be made for a simple empty location (ambient air), which makes it possible to easily incorporate the reference channel into the spectrometer.

Alternatively, calibration can be carried out by initially analyzing a reference sample, then a sample to be analysed.

The invention also relates to a fluorescence or absorption imaging apparatus, comprising means for illuminating a sample. The means for illuminating the sample comprise a device M for the emission of a controlled-spectrum light beam according to the invention or an installation M² for the emission of a controlled-spectrum light beam according to the invention.

The imaging apparatus according to the invention can form a fluorescence microscopy apparatus and comprise:
collection means arranged for collecting a return signal comprising a fluorescence light beam emitted by the sample to be analysed, and
means for the optical magnification of the return signal.

Similarly, the imaging apparatus according to the invention can form an absorption microscopy apparatus and comprise:
collection means arranged for collecting a return signal comprising a light beam reflected or back scattered by the sample to be analysed, and
means for the optical magnification of the return signal.

The fluorescence microscopy apparatus according to the invention can comprise feedback means capable of modifying the light intensity of each light source as a function of the intensity of the fluorescence light beam emitted by the sample in response to the absorption of the corresponding wavelength λ₁ or λ₂ respectively.

Similarly, the absorption microscopy apparatus according to the invention can comprise feedback means capable of modifying the light intensity of each light source depending on the intensity of the light beam reflected or back scattered by the sample in response to the absorption of the corresponding wavelength λ₁ or λ₂ respectively.

The fluorescence or absorption microscopy apparatus according to the invention can comprise modulation means arranged in order to modulate the light intensity of each of the light sources at frequencies that are different from each other. Signal processing means can be arranged for demodulating the signal delivered by a detector (for example display means) synchronously with the light sources.

The invention also relates to a multispectral imaging apparatus for observing at least one sample lit successively by light beams at different wavelengths, comprising:
means for illuminating the sample comprising a device M for the emission of a controlled-spectrum light beam according to the invention or an installation M² for the emission of a controlled-spectrum light beam according to the invention,
the control means for the separate light sources, arranged in order to activate one at a time a single light source at each moment, and
imaging means.

The invention relates generally to a use of a device M for the emission of a controlled-spectrum light beam according to the invention or an installation M² for the emission of a controlled-spectrum light beam according to the invention, in order to form illumination means in any apparatus such as a spectrometry apparatus or an imaging apparatus. All of the advantages stated in respect of the emission device according to the invention reside in these different uses (in particular, the adaptability of the emission, and the spectral control of the emission).

The invention can also relate to a use of an emission device M according to the invention or an emission installation M² according to the invention, for forming lighting means optimizing the colour rendering of an object (in a museum, a jeweller's shop, an apparatus for inspecting teeth for a dentist's use, etc).

Finally, the invention relates to a light emission unit comprising at least three semiconductor chips each emitting a quasi-monochromatic light beam at an emission wavelength λ₁ or λ₂ or λ₃ respectively. The semiconductor chips are ranked by chromatic order as a function of their emission wavelength.

The emission wavelength of a chip is the wavelength corresponding to its maximum intensity over its emission spectrum. This wavelength is generally at the centre of its emission spectrum if the latter is bell-shaped.

The term “chip” is used in English to denote a semiconductor chip. More specifically, the term “microchip” can be used. The term “LED chip” can also be used for a semiconductor chip emitting a light beam.

The light emission unit according to the invention adopts the general principle of multicore LEDs (known as “multichip LEDs” in English), but modifies it. In the prior art, multicore LEDs are produced in order to optimize the intensity of emission of the LED. Each semiconductor chip thus has one and the same emission spectrum. According to the invention, on the contrary, it is desired that each semiconductor chip shall have a completely different emission wavelength. Moreover, according to the invention, the semiconductor chips are placed according to their emission wavelength. Moreover, according to the invention, the semiconductor chips can be numerous, for example provision can be made for twelve in one and the same light source.

The semiconductor chips can be coplanar.

More particularly, the semiconductor chips can be aligned. Provision can also be made for them to be distributed along an arc of a circle, or of an ellipse, or of any other conical arc.

Preferably, the width of a semiconductor chip is less than 1 mm, for example comprised between 90 μm and 500 μm or even between 90 μm and 200 μm. Reference is made to the width of a semiconductor chip, for denoting its measured dimension along its smallest dimension.

The distance between two neighbouring diodes is advantageously comprised between 90 μm and 500 μm. This distance can vary in particular depending on the spectral width of each semiconductor chip, and the difference between the emission wavelengths of two neighbouring semiconductor chips. This distance depends on the number of semiconductor chips that it is desired to use in the light source according to the invention.

The distance between two neighbouring diodes may be fixed.

Alternatively, the distance between a first diode and the neighbouring diode varies with the emission wavelength of the first diode and the emission wavelength of the neighbouring diode.

In particular, the light emission unit according to the invention can be capable of being used in a device for emitting a controlled-spectrum light beam according to the invention, in order to form the light sources. Thus, the invention can relate to a device for emitting a controlled-spectrum light beam such as described previously, in which the light sources are formed by such a light emission unit.

### DESCRIPTION OF THE FIGURES AND EMBODIMENTS

Other advantages and features of the invention will become apparent from reading the detailed description of implementations and embodiments which are in no way limitative, and from the following attached drawings:

FIG. 1 shows the emission spectra of two light sources utilized in a device for emitting a controlled-spectrum light beam according to the invention;

FIG. 2 shows a first embodiment of an emission device according to the invention,

FIG. 3 shows a second embodiment of an emission device according to the invention,

FIG. 4 shows a third embodiment of an emission device according to the invention,

FIG. 5 shows a fourth embodiment of an emission device according to the invention,

FIG. 6 shows an embodiment of an emission installation according to the invention.

FIG. 7 shows an embodiment of an absorption spectrometer according to the invention.

FIG. 8 shows an embodiment of a fluorescence spectrometer according to the invention.

FIG. 9 shows an embodiment of a fluorescence microscopy apparatus according to the invention.

FIG. 10 shows an embodiment of a multispectral imaging apparatus according to the invention; and

FIG. 11 shows an embodiment of a light emission unit according to the invention.

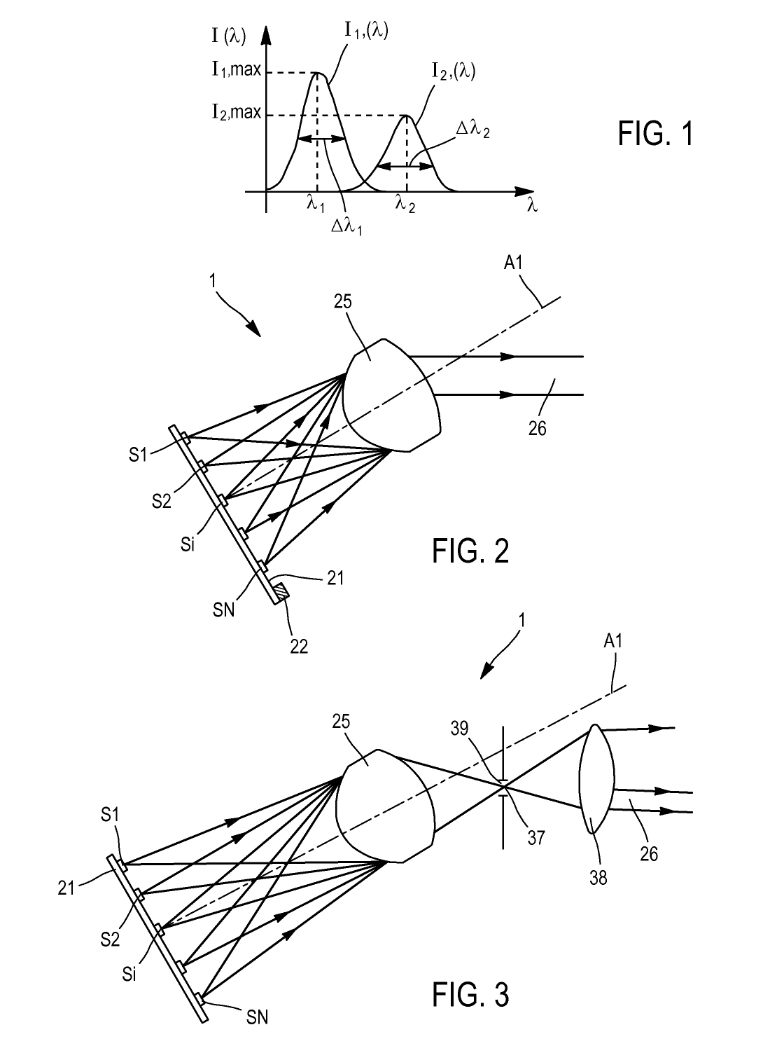

Firstly, with reference to FIG. 1, the emission spectra of two light sources utilized in an emission device according to the invention will be described.

The light intensity is marked I₁(λ) or I₂(λ) respectively, of two light sources that are quasi monochromatic at wavelengths λ₁ or λ₂ respectively. Each spectrum I₁(λ) or I₂(λ) respectively, is “bell-shaped” (for example a Gaussian distribution) having a peak at the wavelength known as the operating wavelength λ₁ or λ₂ respectively. This peak has a full width at half maximum that is relatively small with respect to the operating wavelength.

Thus, a first light source S1 has a bell-shaped emission spectrum with:
a peak of height I_{1,max} (maximum value of the light intensity I₁(λ), i.e. I_{1,max}(λ₁)) for the operating wavelength λ₁=340 nm, and
a full width at half maximum λλ₁ around the peak at λ₁, here equal to 10 nm.

In the same way, a second light source S2 has a bell-shaped emission spectrum with:
a peak of height I_{2,max} (maximum value of the light intensity I₂(λ), i.e. I_{2,max} (λ₂)) for the operating wavelength λ₂=405 nm, and
a full width at half maximum Δλ₂ around the peak at λ₂, here equal to 10 nm.
   The light sources S1 and S2 can then be regarded as quasi monochromatic, because:
the full width at half maximum Δλ₁ of the light source S1 is small with respect to the wavelength λ₁ because Δλ₁/λ₁<<1
the full width at half maximum Δλ₂ of the light source S2 is small with respect to the wavelength λ₂ because Δλ₂/λ₂<<1.

Provision can also be made to use polychromatic sources having other spectral shapes. According to the invention, as a function of the position of the light source, only a portion of its spectrum centred on a wavelength known as an operating or emission wavelength will be used. It is therefore possible to use a polychromatic source, provided that its spectrum has a high intensity at this operating wavelength.

The light sources here comprise light-emitting diodes (“LEDs” in English for “Light-Emitting Diodes”). The use of light-emitting diodes makes it possible to reduce the risks of failure, LEDs being light sources that have a longer life than the light sources usually utilized in devices such as spectrometers, such as incandescence or discharge sources. Moreover, LEDs have the advantage of smaller size.

With reference to FIG. 2, a first embodiment of a controlled-spectrum light beam emission device 1 according to the invention will be described.

In this embodiment, there are twelve light sources. For reasons of the legibility of the figure, only five light sources have been shown: S1, S2, Si, SN, where N=12. Provision can be made however for as many light sources as desired.

These light sources S1 to S12 are regarded as quasi monochromatic sources, each emitting a light beam at the wavelengths λ₁ to λ₁₂ respectively.

By quasi monochromatic sources is meant a light source the emission spectrum of which is narrow in wavelength. This may be understood in the light of FIG. 1, in which the emission spectra of light-emitting diodes S1 and S2 are shown.

In addition to the light sources S1 and S2 described with reference to FIG. 1, the ten other light sources S3 to S12 emit light beams at the following wavelengths:
Source S3: λ₃=450 nm;
Source S4: λ₄=480 nm;
Source S5: λ₅=505 nm;
Source S6: λ₆=546 nm;
Source S7: λ₇=570 nm;
Source S8: λ₈=605 nm;
Source S9: λ₉=660 nm;
Source S10: λ₁₀=700 nm
Source S11: λ₁₁=750 nm
Source S12: λ₁₂=800 nm

Sources S1 to S12 are therefore ranked in increasing order of chromaticity.

As a variant, it is possible to use any other wavelength suitable for the application utilized.

Preferably, the wavelengths of the light sources are comprised between 340 nanometres and 800 nanometres.

In this first embodiment, the light sources S1 to S12 are advantageously selected so that their respective emission spectra do not overlap. This means, still taking the example of light sources S1 and S2, the respective spectra of which are shown in FIG. 1, that:

the light intensity I₁(λ₂) of the light source S1 for the wavelength λ₂ is very low with respect to the peak value I_{2,max}, for example less than 5%, preferably less than 1% of this peak value, and that

the light intensity I₂(λ₁) of the light source S2 for the wavelength λ₁ is very low with respect to the peak value I_{1,max}, for example less than 5%, preferably less than 1% of this peak value.

Advantageously, the light sources can each comprise an optical filter placed in front of them, making it possible to limit even further their respective full width at half maximum. This optical filter is a conventional spectral filter known to a person skilled in the art allowing a light beam to be transmitted only over a specific range of wavelengths known as its “pass band”. This filter can be for example an absorption filter, or an interference filter.

The twelve light sources S1 to S12 are, in the embodiment of the invention shown in FIG. 2, light-emitting diodes of the encapsulated type. By this is meant that the light-emitting diodes S1 to S12 here each contain a chip (or a “LED chip” in English) which emits light and is placed in a package making it possible on the one hand to dissipate the heat given off by the chip when the latter is emitting, and, on the other hand, to bring electrical power to the chip for its operation.

The package is therefore generally constituted by a thermally resistant and electrically insulating material such as for example an epoxide polymer such as epoxy resin, or a ceramic.

It generally comprises two metal pins soldered onto the printed circuit board 21 by means of two spots of solder, these solder spots making it possible on the one hand, to fix the light-emitting diode onto the printed circuit board, and on the other hand, to supply the LEDs with current.

As a variant, one and the same package may contain several chips (“multichip LED” in English), the package then generally comprising as many pairs of metal pins as there are chips incorporated in the package. This is then termed a multicore LED. The different chips of the package are identical.

In each variant, provision may be made to replace the metal pins by simple conductive surfaces and use a technique known as SMD for “surface mounted device” (or SMD for “Surface Mounted Device” in English).

Another possibility for the production of the light sources according to the invention will be described below, with reference to FIG. 11.

The printed circuit board 21 or PCB (for “Printed Circuit Board” in English) 21 is here made from a glass-fibre reinforced epoxy resin of the “FR4” type, well known in the art.

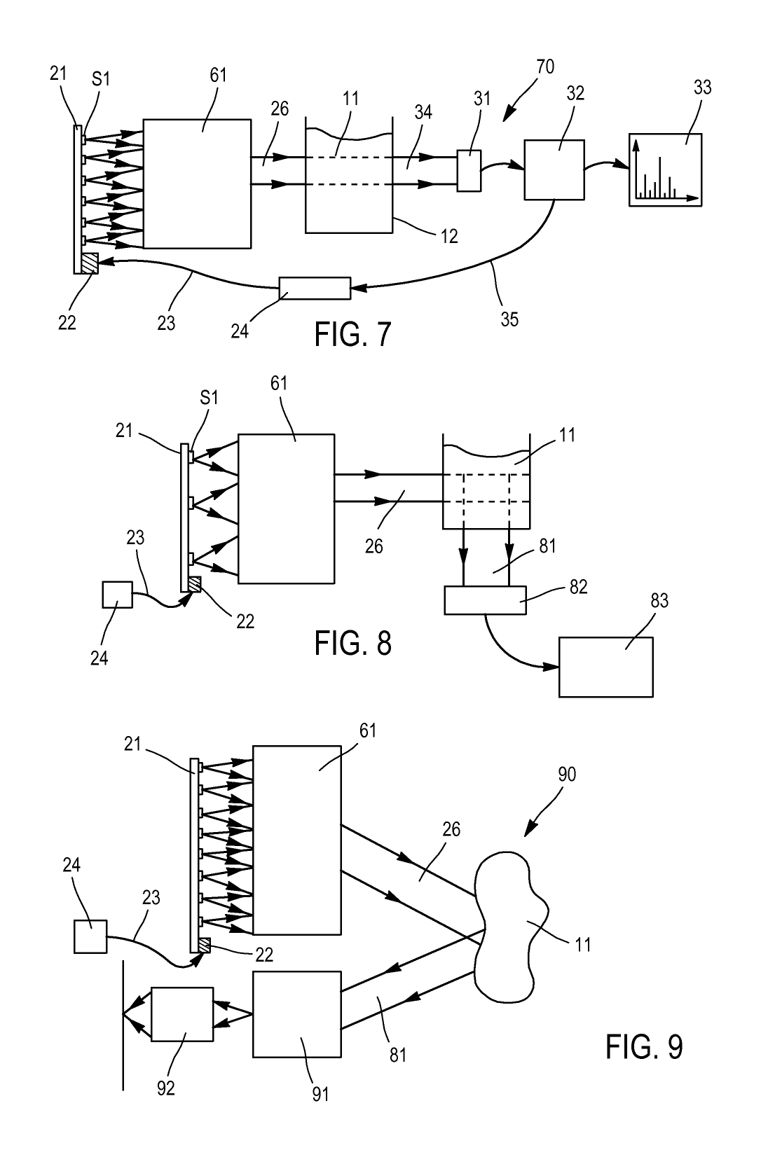

In order to provide the necessary power, the printed circuit board 21 comprises a connector 22. The connector 22 is not shown in all the figures, for reasons of legibility of the figures. With reference to FIG. 7, it will be noted that to this connector 22 is connected a cable 23 linked to a power supply and control box 24 supplying a current adjusted for each of the light-emitting diodes.

The light-emitting diodes S1 to S12 each emit a light beam at their emission wavelength λ₁ to λ₁₂. Each light beam is generally a divergent beam, the LEDs being light sources emitting in a quasi-lambertian manner.

The emission device 1 comprises spectral multiplexing means mixing the light beams of the light sources S1 to S12 in order to form a multiplexed light beam 26.

In the embodiment of the invention shown in FIG. 2, these spectral multiplexing means are formed by an optical assembly itself formed by a thick biconcave lens 25 having an optical axis A1. It is known that such a lens 25 has a lateral chromatic aberration when it is operated off its optical axis A1.

In fact, the lens 25 has foci F1 to F12 corresponding to the wavelengths λ₁ to λ₁₂. Because of the lateral chromatic aberration, these foci are distinct and separate, aligned in a straight line intersecting the optical axis A1 of the lens 25.

The optical feature of these singular points of the lens 25 is that a light beam originating from these points is transmitted and converted by the lens 25 into the form of a light beam having parallel rays, known as a “collimated” light beam.

Thus, a light beam emitted at the wavelength λ₁ from the focus F1 in the direction of the lens 25 emerges from the lens 25 as a parallel light beam at the same wavelength λ₁. In the same way, a light beam emitted at the wavelength λ₂ from the focus F2 in the direction of the lens 25 emerges from the lens 25 as a parallel light beam at the same wavelength λ₂, being superimposed on the parallel light beam at the wavelength λ₁. The two light beams emitted from the foci F1 and F2 are therefore mixed, or “multiplexed” at the output of the lens 25.

This it is understood that by placing the light sources S1 to S12 respectively in the positions of the foci F1 to F12 corresponding to the wavelengths λ₁ to λ₁₂ of the lens 25 having lateral chromatic aberration, the light beams emitted by the LEDs S1 to S12 are multiplexed at the output of the lens 25, in order to form a multiplexed light beam 26, here in the form of a collimated light beam.

The multiplexed light beam 26 is therefore a polychromatic light beam, since it comprises several mixed wavelengths.

FIG. 3 shows a second embodiment of an emission device 1 according to the invention.

FIG. 3 will be described only insofar as it differs from FIG. 2. While in the embodiment shown in FIG. 2, the light sources S1 to S12 are situated at the positions of the foci F1 to F12 corresponding to the wavelengths λ₁ to λ₁₂ of the lens 25, in this embodiment this is not the case. A “point-to-point” optical conjugation is therefore utilized, and not “focus-infinity”. Light sources S1 to S12 are situated at positions such that the lens 25 performs the optical conjugation between the light sources and a common image point 37. A spatial filter hole 39 placed at this image point 37 makes it possible to carry out a spatial filtering on the light beam emerging from the lens 25.

An achromatic collimation lens 38 is placed such that the common image point 37 is placed at its object focus, which makes it possible to obtain a collimated multiplexed beam 26.

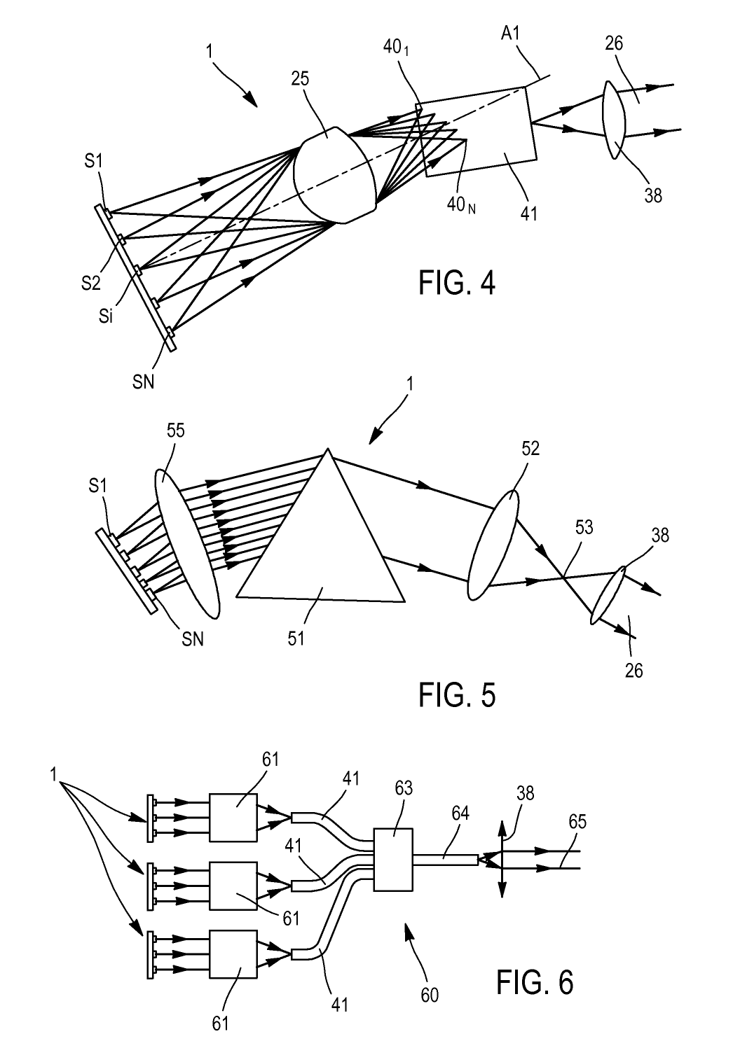

FIG. 4 shows a third embodiment of an emission device 1 according to the invention.

FIG. 4 will be described only in respect of its differences with FIG. 3.

In the example shown in FIG. 4, the geometric aberrations of the lens 25 are such that a common image point is not obtained for the light sources S1 to S12.

Each light source is imaged by the lens 25 at a respective image point 40₁ to 40₁₂. Although the lens 25 does not image the sources S1 to S12 at a single point, it moves the light beams originating from each of the sources closer together. The points 40₁ to 40₁₂ are therefore combined in a focus volume having small dimensions, for example a thick disk that is a few millimetres in diameter and a few millimetres in height. An homogenization waveguide 41 is therefore placed in such a way that the light beams forming the image points 40₁ to 40₁₂, go inside the waveguide 41. The waveguide is for example a liquid-core optical fibre, having a diameter of 3 mm and a length of 75 mm. The light beams originating from each of the sources S1 to S12 are mixed inside the waveguide so that an homogenized light beam is obtained at the output of the waveguide. The beam is called homogenized because the contributions of each of the beams at respective wavelengths are spatially mixed. At the output of the waveguide, an achromatic collimator 38 makes it possible to obtain a collimated multiplexed beam 26. The diameter of the liquid-core optical fibre is considerably larger than the diameter of a conventional optical fibre (a few hundreds of micrometres). A liquid-core optical fibre is chosen, with a diameter of approximately 3 mm, typically between 2 mm and 6 mm, in order to ensure effective coupling in the fibre at the same time as good quality collimation at the output of the fibre.

FIG. 5 shows a fourth embodiment of an emission device 1 according to the invention.

FIG. 5 will be described only insofar as it differs from FIG. 2.

In this embodiment, the spectral multiplexing means comprise an optical assembly formed by an optical prism 51 surrounded by a collimation lens 55 and a focussing lens 52. The collimation lens makes it possible to collimate the light beams emerging from each of the light sources S1 to S12. Thus, several collimated beams are directed to the prism 51. At this stage, the several collimated beams can be spatially separate, or partially superimposed. The prism 51 moves these beams which emerge on the opposite face of the prism spatially closer together so that they are directed toward the focussing lens 52 which spatially combines the light beams emitted by the different light sources at an image point 53.

The prism and lenses assembly is generally used in the context of spectrometers, for spatially separating the different wavelengths. Here, in contrast they are used in order to move beams of different wavelengths spatially closer together, by exploiting the principle of the inverse return of light.

The image point 53 is located at the object focus of an achromatic collimation lens 38, so that a multiplexed collimated beam 26 is obtained at the output of this lens 38.

It can be envisaged to combine the embodiment described with reference to FIG. 5 with the embodiment described with reference to FIG. 4. In particular, if a single image point 53 is not obtained but a group of image points 40_{1 to N} situated in a volume having small dimensions is obtained.

With reference to FIG. 6, an embodiment of an emission installation 60 according to the invention will now be described.

The emission installation 60 according to the invention comprises three emission devices 1 according to the invention.

More precisely, in the embodiment as shown in FIG. 6, the emission installation 60 comprises:
three source units each comprising light sources S1 to SN, where N is greater than five;
for each source unit, an optical assembly 61 as described previously, in particular with reference to FIGS. 3, 4, 5;
at the output of each optical assembly 61, the light beams corresponding to each source unit are focussed on a single point or a plurality of points combined in a focussing area having a small volume (for example a thick disk five millimetres in diameter and 2 millimetres high). The light beams corresponding to each source unit each enter into a respective waveguide 41 which can be an homogenization waveguide.
a fibre splitter 63, which spatially combines the beams propagating in each waveguide 41, in a single waveguide 64 at the output of the fibre splitter 63.
collimation optics 38 common to the three emission devices 1.

A polychromatic collimated multiplexed beam 65 is thus obtained at the output, combining the emission wavelengths of each of the light sources of each emission device 1.

Provision can also be made for a variant of this embodiment, in which dedicated collimation optics 38 correspond to each emission device 1, located in this case upstream of the fibre splitter 63. In this variant, it is possible to advantageously replace the fibre splitter by an arrangement of dichroic mirrors.

All possible variants may be envisaged, utilizing several emission devices 1 as described with reference to FIGS. 2 to 5.

With reference to FIG. 7, an embodiment of an absorption spectrometer 70 according to the invention will now be described. Such a spectrometer makes it possible to carry out an accurate chemical analysis of a sample.

The absorption spectrometer 70 according to the invention has lighting means formed by an emission device 1 according to the invention.

The multiplexed light beam 26 makes it possible to illuminate a sample 11 to be analysed, constituted here by a human blood sample placed in a chamber 12, the characteristics of which will be detailed hereinafter.

Provision can be made for a single sample, with an operator replacing one sample with another between two measurements, or a set of samples placed in parallel so as to simply translate a single support between two measurements.

Provision can be made for a polarizing filter for the light sources, placed in front of the sample on the path of the multiplexed light beam 26. Alternatively, the light sources can each comprise a polarizing filter placed in front of them. This polarizing filter makes it possible to increase the signal-to-noise ratio by dissociating, after transmission through the sample 11 to be analysed, the light absorbed by the latter from the light eventually re-emitted by fluorescence. Moreover, such a polarizing filter would make it possible to also measure the rotatory power of the sample 11 to be analysed, if exhibited thereby.

The multiplexed light beam 26 propagates in order to light illuminate sample 11 to be analysed.

The sample 11 is for example placed in a chamber 12 the walls of which are transparent and are not very absorbent for the wavelengths utilized in the emission device 1. The chamber 12 is here formed of a parallelepipedic tube produced from quartz.

The multiplexed light beam 26 then passes through the sample 11, in which it is absorbed along its path. More precisely, each of the light beams at wavelengths λ₁ to λ₁₂ of the multiplexed light beam 26 is absorbed by the sample 11, the absorption being a priori different for each of the wavelengths λ₁ to λ₁₂.

Advantageously, one or more chemical reagents can be added to the sample 11 to be analysed, making it possible to carry out titration of the sample 11 to be analysed.

On output from the chamber 12, a light beam 34 is obtained transmitted by the sample 11 to be analysed, the spectrum of this transmitted light beam 34 being characteristic of the sample 11, like a partial signature of its chemical composition.

The transmitted light beam 34 is then detected and analyzed by a “detector unit”.

In particular, the detector unit comprises a detector 31, for example a “single-channel” detector, collecting the light beam 34 transmitted by the sample 11 to be analysed. The detector 31 is here a semiconductor photodiode of the silicon type.

As a variant, the detector could be an avalanche photodiode, a photomultiplier or a CCD or CMOS sensor.

The detector 31 then delivers a signal relating to the light flux received for each of the wavelengths λ₁ to λ₁₂. The light flux received at a given a wavelength is linked to the level of absorption of this wavelength by the sample 11.

The signal relating to the light flux received by the detector 31 is transmitted to signal processing means 32 which determine the absorption of each of the wavelengths λ₁ to λ₁₂ by the sample 11 to be analysed. The results of the analysis of the sample 11 are then transmitted to display means 33 representing the results in the form of an absorption spectrum in which the wavelength is shown on the horizontal axis and the level of absorption of the sample 11 on the vertical axis, for example as a percentage, for the wavelength in question.

Power supply and control means 24 are arranged in order to control the light intensity of each of the light sources, for example to modulate the frequency thereof.

Provision can thus be made to modulate the light intensity of each of the light sources S1 to S12 at a frequency different from each other. As explained above, the signals originating from each source can thus be distinguished during detection. Generally, the modulation frequencies are comprised between 1 kilohertz and 1 gigahertz. The signal processing means 32 then demodulate the signal delivered by the detector 31 synchronously with the light sources S1 to S12. This makes it possible in particular to use only a single detector to carry out the measurement.

Alternatively, provision can simply be made to turn each light source on or off, so that at each moment only one of the light sources emits light.

Provision can be made for combining these two embodiments.

This may be referred to as spectral and time control of the spectrum of the multiplexed beam 26.

By separating the different light sources S1 to S12 in this way (by frequency modulation or turning on in succession), the measurement of the absorption on the sample 11 to be analysed is carried out with greater accuracy. In particular, as aforementioned, the detection noise is considerably reduced.

The response time of the LEDs is very rapid, of the order of 100 ns, typically between 10 ns and 1000 ns. Spectral control that is as rapid as this can be termed time-resolved spectroscopy. Such power supply and control means 24 thus make it possible to observe very rapid phenomena. The response time of the LED is of the same order of magnitude as the response time of a suitably chosen photodiode. Owing to such response times both on the emission and reception side, very rapid phenomena can be observed, as these response times (for example of the order of a few hundred nanoseconds) are of the same order as the lifetime of the vibrational and rotational states of the molecules. It is possible for example to observe an absorption phenomenon over time. It is possible for example to observe at what speed the energy levels of a molecule are excited and de-excited.

The absorption spectrometer 70 also contains feedback means which modify the light intensity of each of the light sources S1 to S12 depending on the absorption of each of the wavelengths λ₁, λ₂ by the sample 11 to be analysed.

The feedback means comprise in particular
the power supply and control means 24;
the connection cable 35 between the signal processing means 32 and the power supply and control means 24;
calculation means capable of implementing the feedback.

The signal processing means 32 in fact transmit a signal via the connection cable 35 to the power supply and control means 24 relating to the measurement of the absorption of each of the wavelengths λ₁ to λ₁₂ by the sample 11 to be analysed.

The connection cable 35 thus establishes a feedback loop between the emission device and the detector unit. This feedback loop makes it possible to adapt the intensity of each wavelength in order to operate in the best area of sensitivity and linearity of the detector 31.

The procedure that an operator implements in order to carry out an absorption measurement by means of the absorption spectrometer shown in FIG. 7 will be described hereinafter.

### Calibration Step:

In this step, the operator starts the power supply and control means 24 allowing power to be supplied to the printed circuit board 21 comprising the twelve LEDs S1 to S12 which then each emit a divergent light beam at their respective wavelengths λ₁ to λ₁₂. A multiplexed light beam 26 is then formed, this multiplexed light beam propagating to the chamber 12 in order to illuminate it.

The operator then carries out an “empty” measurement, i.e. in this step, the chamber 12 of the absorption spectrometer is empty and does not yet contain the sample 11 to be analysed. The multiplexed light beam 26 is therefore transmitted almost in its entirety by the chamber 12 as a transmitted light beam 34.

As a variant, the operator can carry out this calibration step with a chamber filled with water at pH=7 (hydrogen potential) the absorption spectrum of which is known.

The detector 31 then collects the transmitted light beam 34 and delivers a signal linked to the light intensity of each of the light beams emitted by the different LEDs S1 to S12, to the signal processing means 32 which record this signal.

At the end of this calibration step, the signal processing means have stored in memory a calibrated value of the light intensity of each of the light beams emitted by each of the light sources S1 to S12 and transmitted through the empty chamber 12 of the absorption spectrometer.

### Measurement Step:

In this step, the operator carries out a new measurement taking care to place the sample 11 to be analysed in the chamber 12 of the absorption spectrometer.

Thus, at the end of this measurement step, the signal processing means have therefore stored in memory a measured value of the light intensity of each of the light beams emitted by each of the light sources S1 to S12 and transmitted via the chamber 12 of the absorption spectrometer 10 filled by the sample 11 to be measured.

The signal processing means 32 then determine, for each of the wavelengths λ₁ to λ₁₂, the ratio between the value calibrated in the calibration step and the value measured in the measurement step, this ratio being linked to the absorption of each of the monochromatic light beams forming the multiplexed light beam 26.
The results are then displayed on the display means 33 in the form of a graph that the operator can view.

Depending on the relative levels of absorption from one wavelength to another, the operator can deduce therefrom the nature of the sample 11. Each chemical compound has a known an absorption spectrum. The spectrum of the sample 11 is therefore a superimposition of known spectra weighted by a concentration. By deconvolution, the fraction of each chemical compound in the spectrum of the sample can be found. The high measurement sensitivity offered by the invention (as explained above), improves the accuracy of this analysis of the chemical composition.

With reference to FIG. 8, a fluorescence spectrometer 80 according to the invention will now be described.

FIG. 8 will be described only insofar as it differs from FIG. 7.

In this embodiment, the multiplexed light beam 26 is directed toward the sample 11. In response to the absorption of the multiplexed light beam 26, the sample emits a fluorescence beam 81.

A detector 82 receives this fluorescence beam 81. The detector 82 can for example consist of a photodiode or a spectrometer. Measurement of the fluorescence spectrum makes it possible to identify the constituents of the sample 11.

The detector 82 is linked to signal processing means 83. If the detector 82 is a spectrometer, the signal processing means can form an integral part of the spectrometer.

Provision can be made for feedback means (not shown) comprising in particular
the power supply and control means 24;
a connection cable (not shown) between the signal processing means 83 and the power supply and control means 24;
calculation means capable of implementing the feedback.

The signal processing means 83 in fact transmit a signal via the connection cable 35 to the power supply and control means 24 relating to the measurement of the fluorescence signal associated with each of the wavelengths λ₁ to λ₁₂.

Such a feedback loop makes it possible to operate in the best area of sensitivity and linearity of the detector 82.

With reference to FIG. 9, a fluorescence microscopy apparatus 90 according to the invention will now be described.

FIG. 9 will be described only insofar as it differs from FIG. 8.

The sample 11 can consist of a biological tissue.

The fluorescence beam 81 is directed toward collection means 91 such that an arrangement of at least one lens makes it possible to collect the fluorescence beam 81 in its entirety.

The fluorescence beam 81 is then guided to optical magnification means 92 which focus an enlarged image of an observation area of the sample 11, for example on the retina of the eye of a observer. An image can thus be obtained of the fluorescence signal emitted by the sample 11, for example in order to locate within the sample certain particular constituents having previously been labelled with fluorescent molecules.

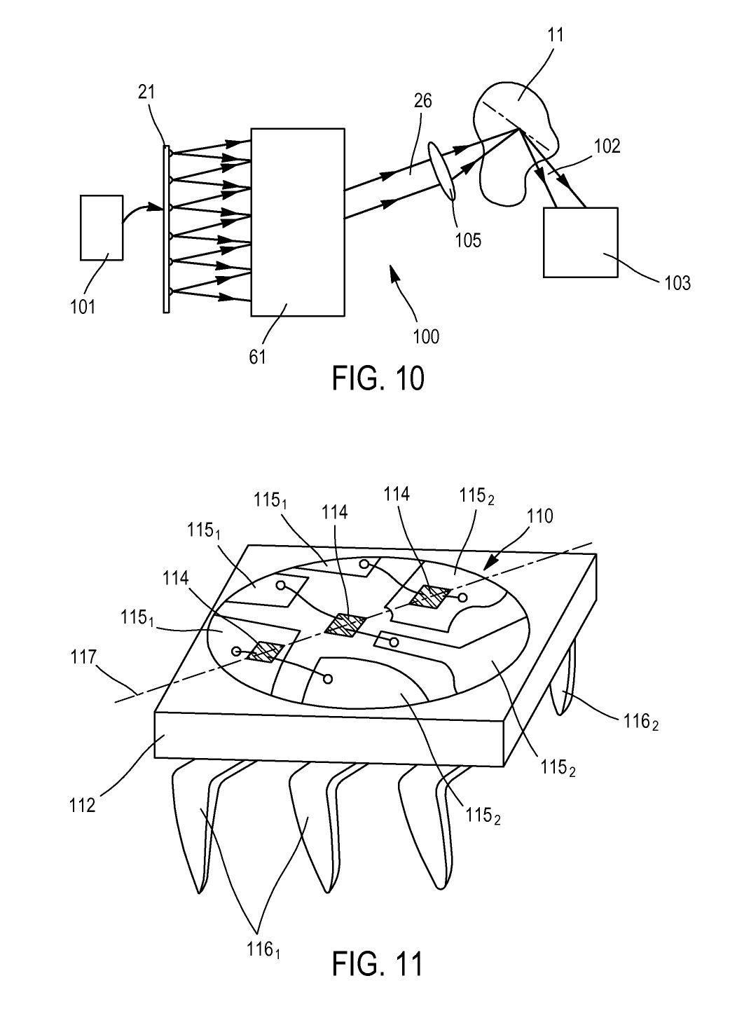

With reference to FIG. 10, a multispectral imaging apparatus 100 according to the invention will now be described.

The multispectral imaging apparatus 100 according to the invention has lighting means formed by an emission device 1 according to the invention.

The multiplexed light beam 26 makes it possible to illuminate a sample 11 to be analysed, constituted here by a sample of human tissue, within the context of an in vivo observation.

A focussing lens 105 focuses the multiplexed light beam 26 onto a particular site on the sample 11 to be analysed.

In multispectral imaging, several images are captured, each image corresponding to a very narrow band of the spectrum. Thus a much more precise definition is achieved of the light reflected by a surface and characteristics that are not visible to the naked eye can be acquired. The spectral bands can be chosen as a function of the wavelengths that are characteristic of the materials or products to be analysed. This can be done by selecting the different light sources S1 to S12.

The multispectral imaging apparatus 100 therefore comprises control means 101, comprising power supply and control means for the light sources as well as calculation means arranged in order to successively activate one of the several light sources. These successive activations can be controlled manually, or can be automated.

The focussed light beam 26 is reflected on the sample 11 as a reflected beam 102, and propagates to imaging means 103 comprising for example sets of lenses and if appropriate a display screen.

Very rapid events can thus be monitored, in particular in the context of an in vivo observation.

FIGS. 7 to 10 show different applications of the emission device according to the invention. All possible combinations of these applications, and the different embodiments of the emission device described with reference to FIGS. 2 to 5 can be envisaged. It can also be envisaged, in each example described with reference to FIGS. 7 to 10, to replace the emission device according to the invention by an emission installation according to the invention (FIG. 6).

Finally, with reference to FIG. 11, an embodiment of a light emission unit 110 according to the invention will now be described.

The light emission unit 110 comprises three semiconductor chips 114, shown with a hatched design. The doping of each semiconductor chip makes it possible to determine the central emission wavelength of the chip, as well as the emission width. The chips are incorporated within a single component. This component can be made from plastic or ceramic. Each chip is bonded with electrically insulating adhesive onto a substrate (for example aluminium), and even sometimes directly onto an electrode. Each chip is micro-soldered to two dedicated electrodes 115₁ or 115₂ respectively by soldering with gold wire. Production of the light emission unit will not be described any further, as the invention resides in the choice and arrangement of the chips of the emission unit.

The light emission unit 110 according to the invention is an SMD component. FIG. 11 shows the light emission unit 110 linked to a support 112 comprising metal pins 116₁ or 116₂ respectively. Each metal pin 116₁ or 116₂ respectively is electrically linked to an electrode 115₁ or 115₂ respectively. These metal pins allow simplified wiring on a printed circuit board.

Each semiconductor chip 114 is for example in the form of a square having sides of 500 μm. The distance between two semiconductor chips 114 is of the order of 1.5 mm. This distance is measured along a straight line 117 along which the semiconductor chips are aligned.

Of course, the invention is not limited to the examples which have just been described and numerous adjustments can be made to these examples without exceeding the scope of the corresponding invention.

In particular all the features, forms, variants and embodiments described previously can be combined together in various combinations to the extent that they are not incompatible or mutually exclusive with one another.

Variants known as “multi-channel” can also be envisaged, i.e. comprising in addition means for spatial separation of the multiplexed beam into several beams of the same spectrum.

1-15. (canceled)

16. Device (1) for emitting a light beam with a controlled spectrum containing at least two separate light sources (S_{1 to N}) each emitting a light beam at at least one wavelength λ₁ or λ₂ respectively, as well as spectral multiplexing means (25; 51, 55, 52; 25, 41), characterized in that
the spectral multiplexing means (25; 51, 55, 52; 25, 41) comprise an optical assembly (25; 51, 55, 52) formed from at least one lens (25; 51, 52) and/or an optical prism (51), said optical assembly (25; 51, 55, 52) having chromatic dispersion properties and being arranged in order to be passed through by the light beams from the separate light sources (S_{1 to N}), without spectrally selective reflection, and in order to move said light beams spatially closer together thanks to the chromatic dispersion properties of the optical assembly, so that the spectral multiplexing means (25; 51, 55, 52; 25, 41) spatially superimpose said light beams; and
the emission device (1) is arranged so that each light beam at at least one wavelength λ₁ or λ₂ respectively propagates in free space from the corresponding light source (S_{1 to N}) to the optical assembly (25; 51, 55, 52).

17. Device (1) according to claim 16, characterized in that the spectral multiplexing means are formed by the optical assembly only (25).

18. Device (1) according to claim 16, characterized in that each light source (S_{1 to N}) is placed on an object focus of the optical assembly (25), where said object focus corresponds to the wavelength of the light beam emitted by this light source (S_{1 to N}), so that at the output of the optical assembly (25) the light beams are spatially superimposed and collimated.

19. Device (1) according to claim 16, characterized in that each light source (S_{1 to N}) is placed at an object point of the optical assembly (25), where said object point corresponds to the wavelength of the light beam emitted by this light source, and so that at the output of the optical assembly the light beams are spatially superimposed at a single image point (53).

20. Device (1) according to claim 16, characterized in that the spectral multiplexing means comprise:
the optical assembly (25),
an homogenization waveguide (41) arranged for carrying out a function of homogenization of the different light beams moved spatially closer together by the optical assembly, and
optical collimation means (38),
the optical assembly (25) being arranged in order to send the light beams to the input of the homogenization waveguide (41), the optical collimation means (38) being located at the output of the homogenization waveguide.

21. Device (1) according to claim 20, characterized in that the waveguide (41) is formed by a liquid-core optical fibre.

22. Device (1) according to claim 16, characterized in that the separate light sources (S_{1 to N}) are arranged coplanar with each other.

23. Device (1) according to claim 16, characterized in that the separate light sources (S_{1 to N}) are aligned in a straight line and ranked by increasing order of wavelength λ₁ or λ₂ respectively.

24. Device (1) according to claim 16, characterized in that the optical assembly comprises at least one optical system (25) used off-axis and having a lateral chromatic aberration.

25. Device (1) according to claim 16, characterized in that the optical assembly comprises a doublet or a triplet lens, usually used for the correction of chromatic aberrations.

26. Device (1) according to claim 16, characterized in that the optical assembly comprises an optical prism (51) and optical focussing means (52) and/or optical collimation means (55).

27. Device (1) according to claim 16, characterized in that each light source (S_{1 to N}) is a light-emitting diode.

28. Device (1) according to claim 16, characterized in that it contains at least twelve light sources (S_{1 to N}).

29. Device (1) according to claim 16, characterized in that it also comprises modulation means (24) arranged in order to modulate the light intensity of at least two of the light sources (S_{1 to N}) at frequencies that are different from each other.

30. Device (1) according to claim 16, characterized in that it also comprises control means (24) of the light intensity of at least two of the light sources, independently of each other.

31. Device (1) according to claim 17, characterized in that each light source (S_{1 to N}) is placed on an object focus of the optical assembly (25), where said object focus corresponds to the wavelength of the light beam emitted by this light source (S_{1 to N}), so that at the output of the optical assembly (25) the light beams are spatially superimposed and collimated.

32. Device (1) according to claim 17, characterized in that each light source (S_{1 to N}) is placed at an object point of the optical assembly (25), where said object point corresponds to the wavelength of the light beam emitted by this light source, and so that at the output of the optical assembly the light beams are spatially superimposed at a single image point (53).
